(19) United States
(12) Patent Application Publication
(10) Pub. No.: US 2026/0195814 A1
(43) Pub. Date: Jul. 9, 2026

(54) BLOCKCHAIN SYSTEM FOR SHOWING TRANSACTION STATUS IN REAL TIME

(71) Applicant: GURUFIN INC., Federal Way, WA (US)

(72) Inventors: Jaeseong JEONG, Seoul (KR); Marc KO, Seoul (KR)

(73) Assignee: GURUFIN INC., Federal Way, WA (US)

(21) Appl. No.: 19/559,317

(22) Filed: Mar. 6, 2026

Related U.S. Application Data
(63) Continuation of application No. PCT/KR2024/013522, filed on Sep. 6, 2024.

(30) Foreign Application Priority Data
Sep. 8, 2023 (KR) 10-2023-0119818
Mar. 18, 2024 (KR) 10-2024-0037470
Jul. 30, 2024 (KR) 10-2024-0100746

(51) Int. Cl. G06Q 40/04

(52) U.S. Cl. CPC G06Q 40/053

(57) ABSTRACT

A blockchain system showing a transaction status in real time is provided. The system comprises: a stable blockchain that issues and manages a stable coin having a fixed exchange rate with a predetermined real currency; and a scanning server that provides issuance information of the stable coin.

### CROSS-REFERENCE TO RELATED APPLICATIONS

The present application is a continuation of International Patent Application No. PCT/KR2024/013522, filed on Sep. 6, 2024, which is based upon and claims the benefit of priority to Korean Patent Application Nos. 10-2023-0119818 filed on Sep. 8, 2023, 10-2024-0037470 filed on Mar. 18, 2024 and 10-2024-0100746 filed on Jul. 30, 2024. The disclosures of the above-listed applications are hereby incorporated by reference herein in their entirety.

### BACKGROUND

Embodiments of the present disclosure described herein relate to a blockchain system that shows a transaction status in real time.

Blockchain is a decentralized data storage technology that stores data in blocks, links them together in a chain, and replicates and stores them simultaneously across numerous computers. Instead of storing transaction records on a centralized server, transaction details are sent to all users participating in the transaction. Each transaction requires all participants to share and verify the information, preventing data forgery or tampering.

Conventional blockchain systems face limitations in commercialization due to the extreme price volatility of native tokens and the high and unpredictable gas fees required for transaction processing. To address these issues, blockchain services based on stablecoins have been proposed. However, most of them fail to build independent mainnets and instead are implemented as secondary tokens issued on the mainnets of external public blockchains.

As a result, the corresponding systems remain dependent on the fee structure and network congestion of external mainnets, thereby limiting the uncertainty surrounding gas fees. Accordingly, to achieve the popularization and commercialization of a blockchain, a stable blockchain system needs to be developed that stabilizes values through stablecoins, while maintaining a fixed and predictable gas fee based on an independent mainnet and minimizing transaction cost volatility.

### SUMMARY

Embodiments of the present disclosure provide a blockchain system that shows a transaction status in real time.

Problems to be solved by the present disclosure are not limited to the problems mentioned above, and other problems not mentioned will be apparent by those skilled in the art from the following description.

According to an embodiment, a blockchain system that shows a transaction status in real time includes a stable blockchain that issues and manages a stablecoin having a fixed exchange rate with a predetermined real currency, and a scanning server that provides issuance information of the stablecoin. The stable blockchain issues or distributes the stablecoin in an amount equal to an amount corresponding to a deposit amount made into an account linked to the stable blockchain.

Moreover, the stable blockchain may be connected to an external server that transmits deposit information to the stable blockchain when the deposit amount in the predetermined real currency is identified in the account linked to the stable blockchain.

Furthermore, the scanning server may output a transaction status of the stable blockchain based on the deposit information and the issuance information.

Also, the scanning server may output a ratio of the deposit amount to an amount of the issued or distributed stablecoin.

Besides, the external server may identify an account in which the deposit amount is deposited, and may transmit the deposit information to the stable blockchain while requesting issuance or distribution of the deposit amount in the stablecoin, when the account is an account of the stable blockchain.

In addition, the stable blockchain may issue or distribute the deposit amount in the stablecoin based on an initial issuance amount of the stablecoin.

Moreover, the stable blockchain may be operated by each country singly or in multiple, and a stablecoin currency unit of the stable blockchain for each country may be identical to a currency unit for each country.

Furthermore, the stable blockchain for each country having different stablecoin currency units may exchange transaction-related information with each other through exchange into a currency unit with price fluctuations through a group station.

Besides, a device for implementing the present disclosure, a method, and a computer program stored in a computer-readable recording medium for executing the method, and a computer-readable recording medium recording a computer program for executing the method may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram illustrating a hybrid blockchain system, in which a plurality of blockchains are combined, according to a first embodiment of the present disclosure;

FIG. 2 is a diagram illustrating a first blockchain, according to the first embodiment of the present disclosure;

FIG. 3 is a diagram illustrating a second blockchain, according to the first embodiment of the present disclosure;

FIG. 4 is a diagram illustrating a second blockchain operated by each country, according to the first embodiment of the present disclosure;

FIG. 5 is a flowchart of a hybrid blockchain-based rewards method implemented by a hybrid blockchain system, in which a plurality of blockchains are combined, according to the first embodiment of the present disclosure;

FIG. 6 is a schematic diagram illustrating a blockchain system that displays transaction status in real time, according to the second embodiment of the present disclosure;

FIG. 7 is a diagram illustrating a webpage that displays transaction status, according to the second embodiment of the present disclosure; and

FIG. 8 is a flowchart of a real-time transaction status provision method executed by a blockchain system displaying a transaction status in real time, according to the second embodiment of the present disclosure.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components. Throughout this specification, when it is supposed that a portion is “connected” to another portion, this includes not only a direct connection, but also an indirect connection. The indirect connection includes being connected through a wireless communication network. Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, an ‘apparatus’includes all various devices capable of providing results to a user by performing arithmetic processing. For example, the device according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Existing blockchains suffer from high price fluctuations and relatively high gas fees. Accordingly, the introduction of stablecoins has resolved the issue of price volatility. However, because stablecoins utilize an external mainnet rather than their own, there is still the issue of having to pay for external mainnet usage.

The present disclosure provides a hybrid blockchain system in which a blockchain without price fluctuations and a blockchain with price fluctuations are combined to each other. Accordingly, it is possible to provide rewards to participants based on price fluctuations while a blockchain is operated with a fixed gas fee.

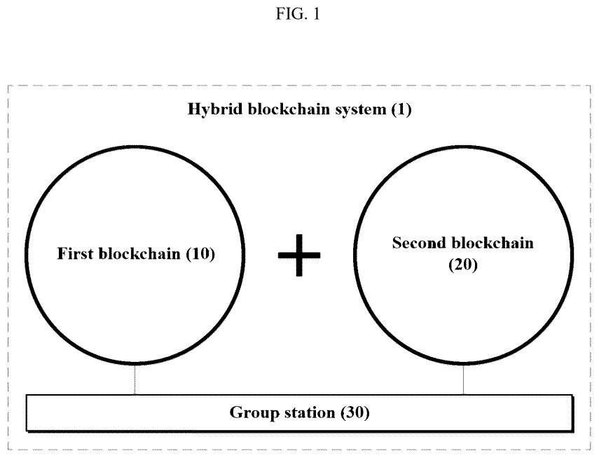

Hereinafter, the first embodiment of the present disclosure will be described in detail with reference to the attached FIGS. 1 to 5.

FIG. 1 is a schematic diagram illustrating a hybrid blockchain system 1, in which a plurality of blockchains are combined, according to the first embodiment of the present disclosure.

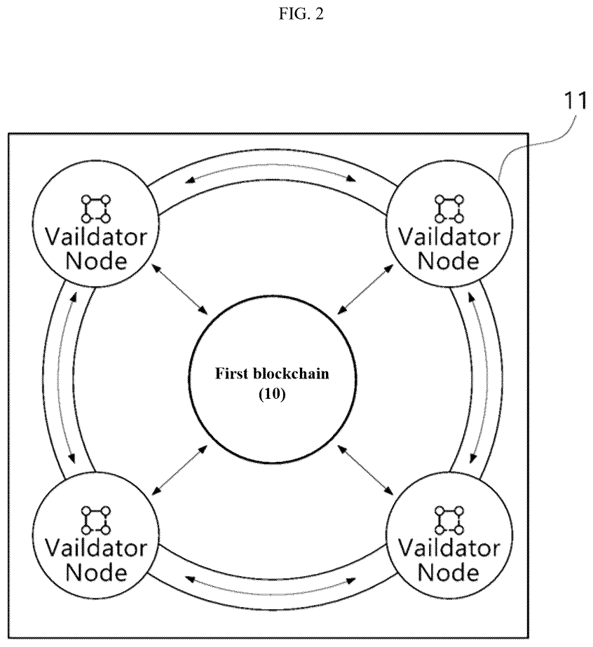

FIG. 2 is a diagram illustrating a first blockchain, according to the first embodiment of the present disclosure.

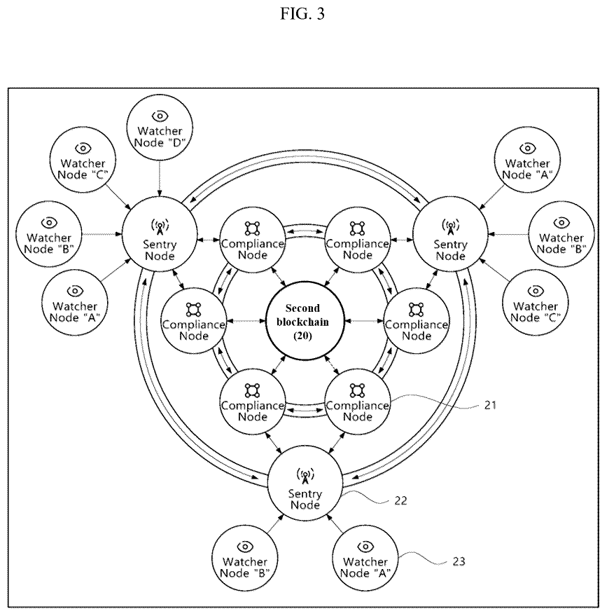

FIG. 3 is a diagram illustrating a second blockchain, according to the first embodiment of the present disclosure.

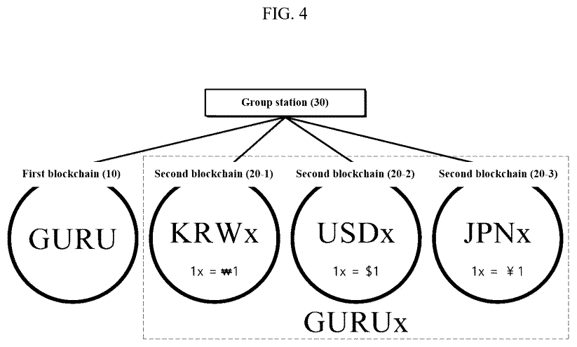

FIG. 4 is a diagram illustrating a second blockchain operated by each country, according to the first embodiment of the present disclosure.

Referring to FIG. 1, the hybrid blockchain system 1, in which a plurality of blockchains are combined, according to a first embodiment may include a first blockchain 10, a second blockchain 20, and a group station 30. However, in some embodiments, the system 1 may include fewer or more components than the components illustrated in FIG. 1.

The first blockchain 10 may not have a fixed first usage fee, and may provide rewards to a first node according to price fluctuations.

Here, the first usage fee may refer to a gas fee required to use the first blockchain 10. The first usage fee may fluctuate depending on price fluctuations of the first currency used in the first blockchain 10.

The first node may refer to participants who perform consensus on transactions occurring in the first blockchain 10.

The second blockchain 20 may have a fixed second usage fee and may provide rewards to a second node based on price fluctuations of the first blockchain 10.

Here, the second usage fee may refer to a gas fee required to use the second blockchain 20.

The second blockchain 20 may be based on a stablecoin. Since the unit of the second currency used in the second blockchain is the same as the unit of fiat currency, the second usage fee may be a fixed price.

The gas fee for the first blockchain (the first usage fee) may be paid with GURU, which is the first blockchain's coin, or GURUx that is the stablecoin for the second blockchain. When the gas fee for the first blockchain is paid with GURUx, the price remains constant even when a token price of the first blockchain fluctuates.

The gas fee for the second blockchain (the second usage fee) may be paid with GURUx that is the second blockchain's stablecoin.

In this case, when the gas fee is paid with GURUx, the gas fee may be paid with a reserve currency (e.g., USDx). The reserve currency may be pegged to USDx that is based on the US dollar, but is not limited thereto, and may also be assigned as another reserve currency, such as EURx.

Here, GURU may refer to the first currency unit of the first blockchain. The corresponding name may not be limited to GURU and may be given a different name. The GURUx may refer to the stablecoin-based second currency unit of the second blockchain. The corresponding name may not be limited to GURUx and may be given a different name.

Each of the first blockchain 10 and the second blockchain 20 may build and utilize their own mainnets. Each blockchain may independently perform consensus (validation) and a reward for transactions occurring on each blockchain, by using their own mainnets. However, the reward on the second blockchain 20 is provided based on price fluctuations on the first blockchain 10.

The usage fees for the first blockchain 10 and the second blockchain 20 are described separately above. However, this is not limited thereto. According to an embodiment, the first blockchain 10 and the second blockchain 20 may pay usage fees together.

Furthermore, the first blockchain 10 and the second blockchain 20 may be based on Proof of Stake (PoS). Accordingly, participants may be granted permissions based on their stake.

Hereinafter, the first blockchain 10 will be described in detail with reference to FIG. 2.

The first node of the first blockchain 10 may include a first validator. Here, the first node may refer to a machine or device (such as a PC, tablet, or smartphone) used by a participant of the first blockchain 10.

The first blockchain 10 may grant the qualification of the first validator to a node, which satisfies the predetermined first condition, from among a plurality of first nodes. As mentioned above, since the first blockchain 10 is based on a PoS method, a node, in which the amount of held cryptocurrency satisfies the first condition, may receive the qualification of the first validator and may check the validity of transactions.

Referring to FIG. 2, the first blockchain 10 is configured in a form in which a plurality of first validators (validator nodes) 11 are connected to each other. The plurality of first validators 11 may validate generated transactions and may generate blocks through consensus. Moreover, the first validator may receive a reward for its participation.

FIG. 2 illustrates the four first validators 11, but the number of first validators 11 is not limited thereto.

Hereinafter, the second blockchain 20 will be described in detail with reference to FIGS. 3 and 4.

The second node of the second blockchain 20 may include a second validator, a sentry, a watcher, and a merchant. Here, the second node may refer to a machine or device (such as a PC, tablet, or smartphone) used by a participant of the second blockchain 20.

The sentry may serve to deliver information between the second validator and the watcher.

In detail, a plurality of second validators may generate a block through consensus. Information about the generated block may be delivered to a plurality of sentries. Each of the plurality of sentries may deliver the information about the block to a plurality of connected watchers.

The second blockchain 20 may grant the qualification of a watcher to a node, which satisfies a pre-defined second condition, from among a plurality of second nodes. As described above, since the second blockchain 20 is based on PoS, a node, in which the amount of held cryptocurrency satisfies the second condition, may receive the qualification of a watcher and may identify information about the block generated through consensus among validators.

According to an embodiment, when the second validator and the sentry need to meet pre-defined criteria, the qualification may be granted. In this case, the criteria for granting each qualification may vary.

Referring to FIG. 3, the second blockchain 20 is configured in a form in which a plurality of second validators (compliance nodes) 21 connected to each other. The plurality of second validators 21 may validate generated transactions and may generate blocks through consensus. Information about the generated blocks is delivered to a watcher (watcher node) 23 via a sentry (a sentry node) 22. Moreover, the watcher (a watcher node) 23 may receive a reward for its participation.

In this case, the second blockchain 20 may convert a portion of the second usage fee into currency based on price fluctuations in the first blockchain 10 and may provide it as rewards to the watcher.

The second blockchain 20 may use the predetermined amount of the second usage fee as rewards paid to a plurality of watchers. In this case, since the second blockchain 20 is based on stablecoins, it may convert the predetermined amount of the second usage fee into the first currency unit of the first blockchain 10 and may provide rewards to watchers with the converted amount.

In detail, the second blockchain 20 may convert a certain amount of the second usage fee, to be used as a reward, into the first currency unit of the first blockchain 10 through the group station 30 and may provide rewards to watchers with the converted amount.

The second blockchain 20 may use the remaining amount of the second usage fee, which is obtained by deducting a portion used as the reward, as operating costs or may burn the remaining amount.

FIG. 3 illustrates the six second validators 21, the three sentries 22, and four, three, and two watchers 23 connected to each sentry 22. However, the number of second validators 21, the number of sentries 22, and the number of watchers 23 are not limited thereto.

The second blockchain 20 may be operated by country and may be operated singly or in multiple units depending on the purpose.

The stablecoin-based second currency unit of a country-specific second blockchain may be the same as the currency unit of each country. For example, the stablecoin-based second currency unit of the second blockchain 20 in Korea may be the Korean won that is the unit of Korea's fiat currency. The stablecoin-based second currency unit of the second blockchain 20 in the United States may be the US Dollar that is the unit of the U.S. fiat currency. The stablecoin-based second currency unit of the second blockchain 20 in Japan may be the Japanese Yen, which is the unit of Japan's legal currency.

As described above, the group station 30 may be built on a currency exchange system based on the first currency unit of the first blockchain 10.

The country-specific second blockchain 20, which has a different stablecoin-based second currency unit, may exchange transaction-related information with each other by exchanging it into the first currency unit of the first blockchain 10 through the group station 30. Moreover, the reserve currency (e.g., USDx, EURx) is assigned according to the policy. A stablecoin at a point in time when the reserve currency is assigned may be exchanged in place of GURU at the station 30. Depending on situations, a country-specific stablecoin may be converted through the station as needed. Here, GURU may refer to the first currency unit of the first blockchain. The corresponding name may not be limited to GURU and may be given a different name.

Referring to FIG. 4, the second blockchains 20-1, 20-2, and 20-3 of each country in Korea, the United States, and Japan may exchange money with the first currency of the first blockchain 10 through the group station 30 and may exchange transaction information based on the exchanged amount with each other.

That is, the second blockchain 20-1 with the Korean Won as the stablecoin-based second currency unit, the second blockchain 20-2 with the US Dollar as the stablecoin-based second currency unit, and the second blockchain 20-3 with the Japanese Yen as the stablecoin-based second currency unit may each conduct cross-border transactions through exchange into the same currency unit (the first currency of the first blockchain) via group station 30.

In detail, each merchant included in the second blockchain 20 of each country may deposit funds through the group station 30 and may conduct profit-making activities in other countries.

That is, the group station 30 may exchange and deposit the amount for profit-making activities of each merchant on the second blockchain 20 of each country into the first currency unit of the first blockchain 10.

For example, when a Korean merchant based in Korea requests a deposit of 100 won, the group station 30 may deposit the amount (e.g., 200 GURU, where GURU may be the first currency unit of the first blockchain 10), which is obtained by converting 100 won into the first currency of the first blockchain 10, as the deposit for the Korean merchant.

When a US merchant based in the US requests a deposit of 100 dollars, the group station 30 may deposit the amount (e.g., 300 GURU), which is obtained by converting 100 dollars into the first currency of the first blockchain 10, as the deposit for the US merchant.

When a Japanese merchant based in Japan requests a deposit of 100 yen, the group station 30 may deposit the amount (e.g., 230 GURU), which is obtained by converting 100 yen into the first currency of the first blockchain 10, as the deposit for the Japanese merchant.

In this way, merchants in each country may conduct profitable activities in other countries by using the deposit converted into the same currency (the first currency of the first blockchain).

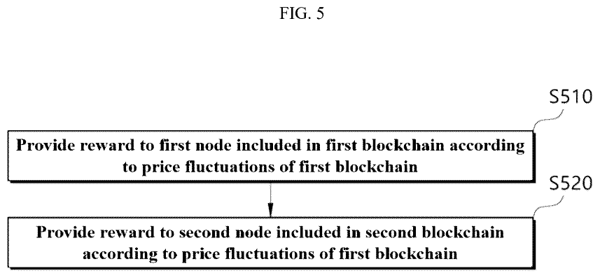

Hereinafter, a method for providing a hybrid blockchain-based reward will be described with reference to FIG. 5.

FIG. 5 is a flowchart of a hybrid blockchain-based rewards method implemented by the hybrid blockchain system 1, in which a plurality of blockchains are combined, according to the first embodiment of the present disclosure. The method described with reference to FIG. 5 may be performed by the system 1, but may also be performed by a hybrid blockchain-based reward provision device (not shown).

Referring to FIG. 5, the first blockchain 10 included in the system 1 may provide a reward to the first node included in the first blockchain 10 according to price fluctuations of the first blockchain 10 (S510). As described above, participants in the first blockchain 10 may receive a reward based on price fluctuations of the first blockchain 10 with GURU.

The second blockchain 20 included in the system 1 may provide a reward to the second node included in the second blockchain 20 based on price fluctuations of the first blockchain 10 (S520). As described above, participants in the second blockchain 20 may receive a reward based on price fluctuations of the first blockchain 10 with GURU.

The details of operations S510 and S520 are identical to those described above with reference to FIGS. 1 to 4, and thus a detailed description thereof will be omitted.

The reward provision device (not shown) may include a communication unit, a memory, and a processor, and the processor may include a first blockchain module, a second blockchain module, and a currency exchange module. Here, the first blockchain module may correspond to the first blockchain 10; the second blockchain module may correspond to the second blockchain 20; and, the currency exchange module may correspond to the group station 30.

In some embodiments, the reward provision device (not shown) and the processor may include fewer or more components.

The communication unit may include one or more modules that enable wireless or wired communication between the reward provision device (not shown) and an external device, or between the reward provision device (not shown) and a communication network. For example, the communication unit may include at least one of a wired communication module, a wireless communication module, a short-range communication module, and a location information module.

Various types of communication networks may be used. For example, wireless communication methods such as wireless LAN (WLAN), Wi-Fi, Wibro, Wimax, High Speed Downlink Packet Access (HSDPA), and the like or wired communication methods such as Ethernet, xDSL (ADSL or VDSL), Hybrid Fiber Coax (HFC), Fiber to The Curb (FTTC), Fiber To The Home (FTTH), and the like may be used in a communication network.

In the meantime, the communication network is not limited to the communication method described above, and may include all types of communication methods widely known or to be developed in the future in addition to the above communication methods.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard232 (RS-232), power line communication, or plain old telephone service (POTS).

Here, the wireless communication module may include a wireless communication module for supporting various wireless communication methods such as Global System for Mobile (GSM) communication, Code Division Multiple Access (CDMA), Wideband Code Division Multiple Access (WCDMA), Universal Mobile Telecommunication System (UMTS), Time Division Multiple Access (TDMA), Long Term Evolution (LTE), 4G, 5G, and 6G in addition to a Wi-Fi module and Wireless broadband module.

The short-range communication module may be used for short range communication, and may support short-range communication by using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB) technologies.

The memory may store at least one process for providing a service that provides a hybrid blockchain-based reward.

The memory may store data supporting various functions of the reward provision device (not shown) and a program for the operation of the processor, may store pieces of input/output data (e.g., music files, still images, videos, and the like), and may store a plurality of application programs (or applications) running on the reward provision device (not shown), data for operations of the reward provision device (not shown), and commands. At least part of the application programs may be downloaded from an external server through wireless communication.

The memory may include the type of a storage medium of at least one of a flash memory type, a hard disk type, a Solid State Disk (SSD) type, a Silicon Disk Drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory may be separate from the reward provision device (not shown), but may be a database connected by wire or wirelessly.

The processor may execute the above-described operations by using a memory that stores data regarding an algorithm for controlling operations of components within the reward provision device (not shown), or a program for implementing the algorithm, and data stored in the memory. At this time, the memory and the processor may be implemented as separate chips. Alternatively, the memory and the processor may be implemented as a single chip.

In addition, the processor may control any one or a combination of the components described above to implement various embodiments according to the present disclosure described above with reference to FIGS. 1 to 4 on the reward provision device (not shown).

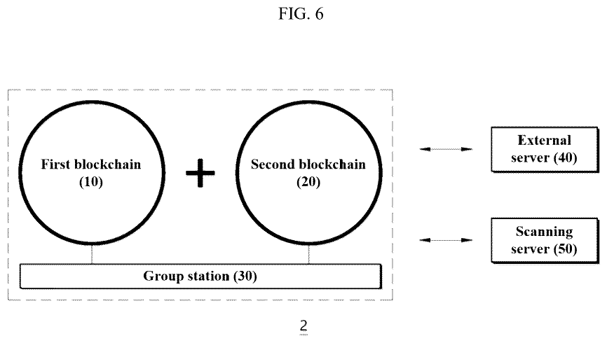

Hereinafter, the second embodiment of the present disclosure will be described in detail with reference to the attached FIGS. 6 to 8.

FIG. 6 is a schematic diagram illustrating a blockchain system 2 that displays transaction status in real time, according to the second embodiment of the present disclosure.

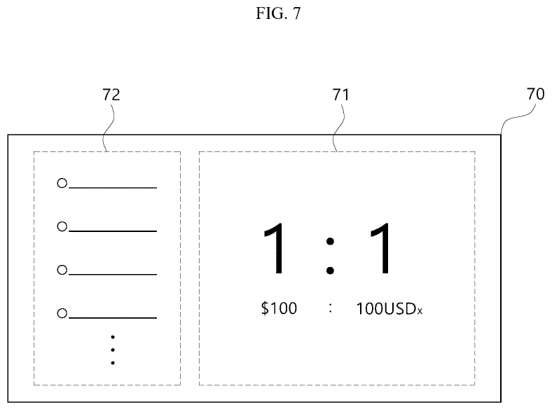

FIG. 7 is a diagram illustrating a webpage that displays transaction status, according to the second embodiment of the present disclosure.

Referring to FIG. 6, the blockchain system 2 showing a transaction status in real time according to the second embodiment may include the first blockchain 10, a stablecoin mainnet (the second blockchain 20 described above), the group station 30, an external server 40, and a scanning server 50. However, in some embodiments, the system 2 may include fewer or more components than the components illustrated in FIG. 6.

The system 2 is further included in the system 1 described above with reference to FIGS. 1 to 5 as components for allowing the external server 40 and the scanning server 50 to provide real-time transaction status. Hereinafter, the first blockchain 10, the stablecoin mainnet 20, the group station 30, the external server 40, and the scanning server 50 will be described with reference to FIGS. 6 to 8 with respect to operations for providing real-time transaction status. However, the first blockchain 10, the stablecoin mainnet 20, and the group station 30 may also perform the operations described with reference to FIGS. 1 to 4.

When a transaction occurs, the system 2 may issue coins corresponding to the deposited amount for the transaction on the first blockchain 10 or the stablecoin mainnet 20 upon request from the external server 40, and may display the status of the transaction in real time by comparing the deposited amount on the website (or a mobile app) with the quantity of issued coins via the scanning server 50. Accordingly, participants of a blockchain may intuitively and visually identify all transactions.

Hereinafter, it is described that a transaction occurs on the stablecoin mainnet 20.

When a transaction occurs, the external server 40 may identify a bank account in which an amount is deposited. When the account is an account on the stablecoin mainnet 20, the external server 40 may request the stablecoin mainnet 20 to issue the deposited amount in a second currency without price fluctuations.

Here, as described above, the second currency may be a stablecoin-based second currency unit used by the stablecoin mainnet 20 and may be named, for example, GURUx.

At the request of the external server 40, the stablecoin mainnet 20 may issue the amount deposited when a transaction occurs in a second currency without price fluctuations and may generate second issuance information about the deposited amount issued into the second currency.

In this case, the stablecoin mainnet 20 may issue the deposited amount in a second currency based on the initial issuance amount of the second currency. That is, issuance for the deposited amount within the remaining coin amount from the initial issuance amount may be performed.

According to an embodiment, when the issuance request is received, the stablecoin mainnet 20 may generate second deposit information, in which the deposited amount is mapped into account information, and may store it in a database. When the issuance is completed, the stablecoin mainnet 20 may identify a wallet address for the transaction based on the account information, and may generate second issuance information, in which the issuance amount of the issued second currency is mapped into the wallet address, so as to be stored in the database.

According to an embodiment, when the issuance request is received, the stablecoin mainnet 20 may generate the second deposit information, in which the deposited amount is mapped into account information. When the issuance is completed, the stablecoin mainnet 20 may identify a wallet address for the transaction based on the account information, and may generate the second issuance information, in which the issuance amount of the issued second currency is mapped into the wallet address, and may record the generated second deposit information and the generated second issuance information in the generated block. When the transaction is completed through consensus among participants (a second node) of the stablecoin mainnet 20, this block may be coupled to a chain.

The scanning server 50 may output the transaction status of the stablecoin mainnet 20 on a second page of a website linked to the system 2 based on the second issuance information.

In detail, the scanning server 50 may output the transaction status of the stablecoin mainnet 20 on the second page of the website based on the second deposit information and the second issuance information. Here, the second page may include a first area indicating the ratio between the deposited amount and the issuance amount of the second currency, and a second area indicating the previous transaction history of the stablecoin mainnet 20.

For example, when the deposited amount is $100 and the issuance amount of the second currency is 100 GURUx, the ratio may be displayed as 1:1.

Referring to FIG. 7, it is described that the reserve currency of the stablecoin mainnet 20 is set to USDx. Referring to FIG. 7, when the deposited amount is 100 USD and the issuance amount of the second currency is 100 USDx, the transaction status in which 100 USD is issued as 100 USDx at a ratio of 1:1 may be displayed in a first area 71 of a second page 70. The previous transaction history of the stablecoin mainnet 20 may be displayed on a second area 72.

Hereinafter, it is described that a transaction occurs on the first blockchain 10.

The external server 40 may identify a bank account in which the amount is deposited when a transaction occurs. When the account is an account on the first blockchain 10, the external server 40 may request the first blockchain 10 to issue the deposited amount in a first currency with price fluctuations.

Here, as described above, the first currency may be a first currency unit used by the first blockchain, and may be called, for example, GURU.

At the request of the external server 40, the first blockchain 10 may issue the amount deposited into the bank account when a transaction occurs in a first currency with price fluctuations and may generate first issuance information about the deposited amount issued into the first currency.

In this case, the first blockchain 10 may issue the deposited amount in the first currency based on the initial issuance amount of the first currency. That is, issuance for the deposited amount within the remaining coin amount from the initial issuance amount may be performed.

According to an embodiment, when the issuance request is received, the first blockchain 10 may generate first deposit information, in which the deposited amount is mapped into account information, and may store it in a database. When the issuance is completed, the first blockchain 10 may identify a wallet address for the transaction based on the account information, and may generate first issuance information, in which the issuance amount of the issued first currency is mapped into the wallet address, so as to be stored in the database.

According to an embodiment, when the issuance request is received, the first blockchain 10 may generate the first deposit information, in which the deposited amount is mapped into account information. When the issuance is completed, the first blockchain 10 may identify a wallet address for the transaction based on the account information, and may generate the first issuance information, in which the issuance amount of the issued first currency is mapped into the wallet address, and may record the generated first deposit information and the generated first issuance information in the generated block. When the transaction is completed through consensus among participants (a first node) of the first blockchain 10, this block may be coupled to a chain.

The scanning server 50 may output the transaction status of the first blockchain 10 on a first page of a website linked to the system 2 based on the first issuance information.

In detail, the scanning server 50 may output the transaction status of the first blockchain 10 on the first page of the website based on first deposit information and the first issuance information. Here, the first page may include a third area indicating the ratio between the deposited amount and the issuance amount of the first currency, and a fourth area indicating the previous transaction history of the first blockchain 10.

For example, when the deposited amount is $100 and the issuance amount of the first currency is 120 GURU, the ratio may be displayed as 1:1.2. In this case, the amount of price fluctuations for the first currency may be displayed in the third area.

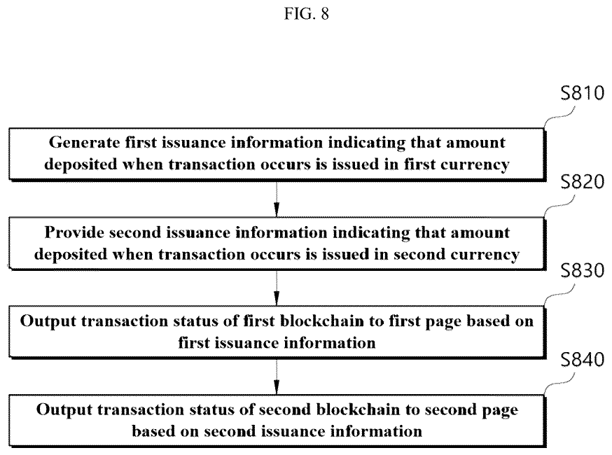

Hereinafter, a method for displaying a transaction status in real time will be described with reference to FIG. 8.

FIG. 8 is a flowchart of a real-time transaction status provision method executed by the blockchain system 2 displaying a transaction status in real time, according to the second embodiment of the present disclosure. The method described with reference to FIG. 8 may be performed by the system 2, but may also be performed by a blockchain-based real-time transaction status provision device (not shown).

The real-time transaction status provision device (not shown) may be identical to the reward provision device (not shown) described above.

Similarly to the reward provision device (not shown), the real-time transaction status provision device (not shown) may include a communication unit, a memory, and a processor. The processor may include a first blockchain module, a stablecoin mainnet module, and a currency exchange module. Here, the first blockchain module corresponds to the first blockchain 10; the stablecoin mainnet module corresponds to the stablecoin mainnet 20; and the currency exchange module corresponds to the group station 30. Moreover, the real-time transaction status provision device (not shown) may communicate with the external server 40 and the scanning server 50 to transmit and receive data.

Furthermore, in some embodiments, the real-time transaction status provision device (not shown) and the processor may include fewer or more components.

In addition, the processor may control any one or a combination of the components described above to implement various embodiments according to the present disclosure described above with reference to FIGS. 6 and 7 on the real-time transaction status provision device (not shown).

Referring to FIG. 8, the first blockchain 10 included in the system 2 may generate first issuance information indicating that an amount deposited when a transaction occurs is issued in a first currency with price fluctuations (S810).

The stablecoin mainnet 20 included in the system 2 may generate second issuance information indicating that an amount deposited when a transaction occurs is issued in a second currency without price fluctuations (S820).

The scanning server 50 included in the system 2 may output a transaction status of the first blockchain 10 to a first page of a website linked to the system 2 based on the first issuance information (S830).

The scanning server 50 included in the system 2 may output a transaction status of the stablecoin mainnet 20 to a second page of the website based on the second issuance information (S840).

When the method for providing a real-time transaction status is performed by a real-time transaction status provision device (not shown), the processor may request the scanning server 50 to output the transaction status of the first blockchain 10 on a first page of a website linked to the system 2 based on the first issuance information, and to output the transaction status of the stablecoin mainnet 20 on a second page of the website based on the second issuance information.

The details of operations S810 and S840 are identical to those described above with reference to FIGS. 6 and 7, and thus a detailed description thereof will be omitted.

As described above, the blockchain system 2 of the present disclosure includes the stablecoin mainnet 20, which issues and manages stablecoins at a 1:1 fixed exchange rate linked to a predetermined real currency, and the scanning server 50, which outputs the issuance and burn status and transaction details in real time.

Only when a deposit of fiat currency is identified in a specified linked account, the stablecoin mainnet 20 is designed to issue stablecoins in quantities equivalent to the deposit amount. The issuance is contingent on the deposit confirmation, and issuance is not performed until the deposit is confirmed, thereby ensuring asset transparency.

Furthermore, only when a withdrawal or refund of fiat currency is identified in a designated account, the stablecoin is designed to burn an amount equivalent to the withdrawal amount, thereby maintaining the accuracy and reliability of the circulating supply.

The external server 40 identifies the deposit or withdrawal of fiat currency. When a transaction is identified in a linked account, the external server 40 transmits the corresponding information to the stablecoin mainnet 20. The stablecoin mainnet 20 issues or burns stablecoins based on this information.

The scanning server 50 may synthesize deposit/withdrawal information and issuance/burn information to output the transaction status of the stablecoin mainnet 20 in real time, and may also calculate and output the ratio and total amount of stablecoins in circulation compared to fiat currency.

Besides, the stablecoin mainnet 20 may operate at each country singly or in multiple, and stablecoins issued on each stablecoin mainnet 20 have a unit equivalent to the legal currency of the corresponding country.

Also, mutual transactions between stablecoin mainnets in different countries are possible through group stations after a currency is converted to another country's currency at a floating exchange rate. Transaction information is then transmitted and received during this process.

FIGS. 5 and 8 illustrates that steps are performed sequentially. However, this is merely illustrative of the technical idea of the present disclosure. Those skilled in the art to which an embodiment of the present disclosure belongs may apply various modifications and variations by changing and performing the order illustrated in FIGS. 5 and 8 or performing it in parallel without departing from the essential characteristics of an embodiment of the present disclosure. FIGS. 5 and 8 are not limited to a time-series order.

In the meantime, in the above description, operations in FIGS. 5 and 8 may be further divided into additional operations or may be combined into fewer operations, according to an embodiment of the present disclosure. In addition, some steps may be omitted as necessary, and the order between steps may be changed.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

According to the above-mentioned problem solving means of the present disclosure, on the basis of stablecoins that are linked 1:1 to fiat currency and issued only when a deposit is identified, users may utilize a blockchain at a stable and predictable price, and the consistency between the circulating supply amount generated during transactions and an actual deposit amount is visualized and displayed in real time, thereby significantly enhancing transaction transparency and reliability.

Moreover, since both the issuance and burning of stablecoins are linked to the confirmation of deposits and withdrawals of fiat currency, the circulating supply amount is precisely controlled, thereby enhancing asset collateralization and reliabilityEffects of the present disclosure are not limited to the effects mentioned above, and other effects not mentioned will be apparent by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A blockchain system that shows a transaction status in real time, the blockchain system comprising:
a stable blockchain configured to issue and manage a stablecoin having a fixed exchange rate with a predetermined real currency; and
a scanning server configured to provide issuance information of the stablecoin,
wherein the stable blockchain issues or distributes the stablecoin in an amount equal to an amount corresponding to a deposit amount made into an account linked to the stable blockchain.

2. The blockchain system of claim 1, wherein the stable blockchain is connected to an external server configured to transmit deposit information to the stable blockchain when the deposit amount in the predetermined real currency is identified in the account linked to the stable blockchain.

3. The blockchain system of claim 2, wherein the scanning server outputs a transaction status of the stable blockchain based on the deposit information and the issuance information.

4. The blockchain system of claim 3, wherein the scanning server outputs a ratio of the deposit amount to an amount of the issued or distributed stablecoin.

5. The blockchain system of claim 2, wherein the external server identifies an account in which the deposit amount is deposited, and transmits the deposit information to the stable blockchain while requesting issuance or distribution of the deposit amount in the stablecoin, when the account is an account of the stable blockchain.

6. The blockchain system of claim 1, wherein the stable blockchain issues or distributes the deposit amount in the stablecoin based on an initial issuance amount of the stablecoin.

7. The blockchain system of claim 1, wherein the stable blockchain is operated by each country singly or in multiple, and
wherein a stablecoin currency unit of the stable blockchain for each country is identical to a currency unit for each country.

8. The blockchain system of claim 7, wherein the stable blockchain for each country having different stablecoin currency units exchanges transaction-related information with each other through exchange into a currency unit with price fluctuations through a group station.
